(19) United States
(12) Patent Application Publication
(10) Pub. No.: US 2026/0366561 A1
(43) Pub. Date: Nov. 19, 2026

(54) FASTENER ASSEMBLY STRUCTURE

(71) Applicant: HYUNDAI MOBIS CO., LTD., Seoul (KR)

(72) Inventors: Sang Won HWANGBO, Yongin-Si (KR); Hee Jin CHOI, Yongin-si (KR)

(73) Assignee: HYUNDAI MOBIS CO., LTD., Seoul (KR)

(21) Appl. No.: 19/662,395

(22) Filed: Apr. 29, 2026

(30) Foreign Application Priority Data
May 19, 2025 (KR) 10-2025-0064859

(51) Int. Cl. F16B 33/00

(52) U.S. Cl. CPC F16B 33/004

(57) ABSTRACT

The present disclosure introduces a fastener assembly structure comprising: a first part in which an assembly hole is formed at a center of a boss portion, and a sealing groove is formed in a structure communicating with an inner surface of the assembly hole such that sealant is injected into an interior thereof; a second part formed in a shape covering the first part; and a fastener extending through the second part and assembled to the assembly hole, wherein as the fastener is assembled to the assembly hole, the sealant rises along the assembly hole and the sealing groove by pressure pressing the sealant to be sealed.

### CROSS-REFERENCE TO RELATED APPLICATIONS

This application claims priority from Korean Patent Application No. 10-2025-0064859 filed on May 19, 2025, in the Korean Intellectual Property Office, the disclosure of which is incorporated herein by reference in its entirety.

### TECHNICAL FIELD

The disclosed embodiment relates to a fastener assembly structure that optimizes a sealant application process by improving an assembly structure of a screw.

### BACKGROUND

ISCM is an integrated safety control module that controls deployment of an airbag upon collision of a vehicle.

In order to satisfy a waterproof function of the ISCM, sealant is applied to a component assembly parting portion and assembled so that water does not enter an interior thereof.

In addition, sealant should also be applied to a screw portion fastened by penetrating through components constituting the ISCM.

However, since the component assembly parting portion has an inclined surface, high viscosity sealant is used for the component assembly parting portion, and low viscosity sealant is used for the screw portion for smooth application of the sealant.

Accordingly, the sealant used in the ISCM is dualized, and the sealant application process is also added, thereby increasing production cost and work effort of the product.

The matters described as the background art above are only for enhancing understanding of the background of the disclosed embodiment, and should not be taken as an acknowledgment that they correspond to the prior art already known to those of ordinary skill in the art.

### SUMMARY

The disclosed embodiment is to provide a fastener assembly structure that optimizes a sealant application process by improving an assembly structure of a screw.

Technical problems to be achieved in the disclosed embodiment are not limited to the technical problems mentioned above, and other technical problems not mentioned may be clearly understood by those of ordinary skill in the art to which the disclosed embodiment belongs from the description below.

A fastener assembly structure according to the disclosed embodiment for achieving the above object comprises: a first part in which an assembly hole is formed at a center of a boss portion, and a sealing groove is formed in a structure communicating with an inner surface of the assembly hole such that sealant is injected into an interior thereof; a second part formed in a shape covering the first part; and a fastener extending through the second part and assembled to the assembly hole, wherein as the fastener is assembled to the assembly hole, the sealant may rise along the assembly hole and the sealing groove by pressure pressing the sealant to be sealed.

The sealant may rise up to a head portion of the fastener.

At least one assembly part may be assembled between the first part and the second part.

A through hole aligned with the assembly hole may be formed in the second part and the assembly part; and the sealant may be filled in the through hole.

The sealing groove may be formed in a circular cross-sectional shape smaller than the assembly hole at least one location along a circumferential direction of the assembly hole.

A plurality of sealing grooves may be formed at equal angles along a circumferential direction about an axis of the assembly hole.

A cross-sectional area where the fastener contacts, among a total cross-sectional area formed by an inner circumferential surface of the assembly hole, may be formed wider than a cross-sectional area of a passage formed between the assembly hole and the sealing groove.

The sealing groove may be formed along a vertical length direction of the assembly hole.

An inner surface of the sealing groove may be formed inclined upward toward an outer side of the boss portion.

The inner surface of the sealing groove may be formed inclined from a lowermost end to an uppermost end.

According to the disclosed embodiment, upon fastening of the screw, since the sealant rises entirely between an outer surface of the screw and inner surfaces of the assembly hole and the sealing groove, airtight performance and waterproof performance are improved by preventing water or air from entering between a housing and a base plate.

Effects obtainable from the disclosed embodiment are not limited to the effects mentioned above, and other effects not mentioned may be clearly understood by those of ordinary skill in the art to which the disclosed embodiment belongs from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a controller of the present disclosure in an exploded state;

FIG. 2 is a view showing a housing of a controller according to the present disclosure;

FIG. 3 is a view showing an assembly hole and a sealing groove according to the disclosed embodiment;

FIG. 4 is a view showing a shape in which sealant is injected into an assembly hole and a sealing groove according to the disclosed embodiment;

FIG. 5 is a view showing a shape in which a screw is assembled to the assembly hole in FIG. 4;

FIG. 6 is a view for explaining a shape and structure of an assembly hole and a sealing groove according to the disclosed embodiment; and

FIG. 7 is a view showing an inclined structure of a sealing groove according to the disclosed embodiment.

### DETAILED DESCRIPTION

In describing the embodiments disclosed in the present specification, when it is determined that detailed description of related known technologies may obscure the gist of the embodiments disclosed in the present specification, the detailed description thereof will be omitted. In addition, the accompanying drawings are only for easily understanding the embodiments disclosed in the present specification, and the technical ideas disclosed in the present specification are not limited by the accompanying drawings, and should be understood to include all modifications, equivalents, and substitutes included in the spirit and technical scope of the present disclosure. The disclosure hereinafter is not intended to limit the present disclosure to the described form or specific field, and it is contemplated that various alternative aspects and modifications to the present disclosure are possible, whether explicitly described or implied in the present specification. Those of ordinary skill in the art to which the present disclosure belongs will recognize that the form and details of the present disclosure may be changed.

The present disclosure is described with reference to specific aspects. However, as understood by those of ordinary skill in the art to which the present disclosure belongs, the various aspects disclosed in the present specification may be modified or otherwise implemented in various other ways without departing from the spirit and scope of the present disclosure. Accordingly, the following description should be considered as illustrative and is for the purpose of teaching those of ordinary skill in the art to which the present disclosure belongs how to make and use various embodiments. It will be understood that the forms of the disclosure shown and described in the present specification will be taken as representative embodiments. Equivalent elements, or materials, processes or steps may be substituted for those representatively exemplified and described in the present disclosure. Expressions such as “including”, “comprising”, “incorporating”, “consisting of”, “have”, “is” and the like used in describing the present disclosure should be interpreted in a non-exclusive manner, that is, to allow items, components or elements not explicitly described to be indicated as well. In addition, references to the singular should be interpreted as including those related to the plural.

In addition, the various embodiments disclosed in the present specification should be taken in an illustrative and descriptive sense and should not be construed as limiting the content of the present disclosure. All references to joining (e.g., attached, affixed, coupled, connected, etc.) are used only to aid understanding of the present disclosure and do not limit the position, orientation or use of the configuration or the methods disclosed in the present specification. Therefore, joining references, where present, should be interpreted broadly. Moreover, in such joining references, it is not assumed that two or more elements are directly connected to each other. Additionally, all numerical terms, for example, “first”, “second”, “third”, “primary”, “secondary”, “main” or any other general or numerical terms, should be taken only as identifiers to assist in understanding various components, forms, variations or modifications of the present disclosure, and do not imply limitations to any component, form, variation or modification or to the order or preference thereof. That is, these expressions may be used to describe various components, but the components are not limited by the expressions. The expressions are used only for the purpose of distinguishing one component from another component.

The suffixes “module” and “portion” for components used in the following description are given or used interchangeably only for ease of writing the specification, and do not have meanings or roles that are distinguished from each other by themselves.

When a component is referred to as being “connected” or “coupled” to another component, it should be understood that the component may be directly connected or coupled to the other component, but other components may also exist in between. On the other hand, when a component is referred to as being “directly connected” or “directly coupled” to another component, it should be understood that no other component exists in between.

In addition, a unit or control unit included in a name is only a term widely used for naming a controller that controls a specific function of a vehicle, and does not mean a generic function unit.

A controller may include a communication device that communicates with other controllers or sensors for control of a function in charge, a memory that stores an operating system, logic commands, input/output information, and the like, and one or more processors that perform determination, calculation, decision, and the like necessary for control of the function in charge.

Any number of components or various components in any of the configurations described in the present specification may be included within the disclosure described in the present specification. The components may include any combination of features described in the present specification and may be arranged in any of the various configurations described in the present specification. Concepts regarding the structure and arrangement of the components of the present disclosure as well as their use and operation may be applied to not only the specific embodiments discussed in the present specification but also any number of embodiments of any combination. Embodiments including those having various features of various arrangements are described below with reference to the drawings.

Hereinafter, various embodiments disclosed in the present specification will be described in detail with reference to the accompanying drawings, and regardless of reference numerals, the same or similar components will be assigned the same reference numbers, and redundant description thereof will be omitted.

A fastener assembly structure according to the present disclosure comprises: a first part 100 in which an assembly hole 110 is formed or disposed at a center of a boss portion 100a, and a sealing groove 120 is formed in a structure communicating with an inner surface of the assembly hole 110 such that sealant S is injected into an interior thereof; a second part 200 is shaped to cover the first part 100; and a fastener 400 extending through the second part 200 and assembled to the assembly hole 110, wherein as the fastener 400 is assembled to the assembly hole 110, the sealant S may rise along the assembly hole 110 and the sealing groove 120 by pressure pressing the sealant S to be sealed.

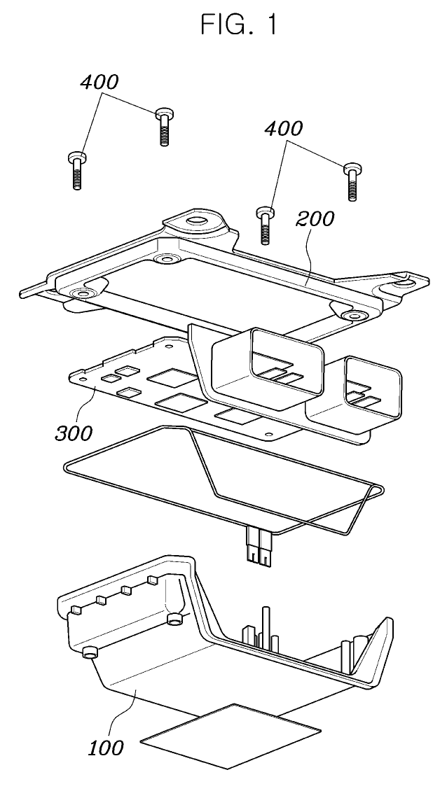

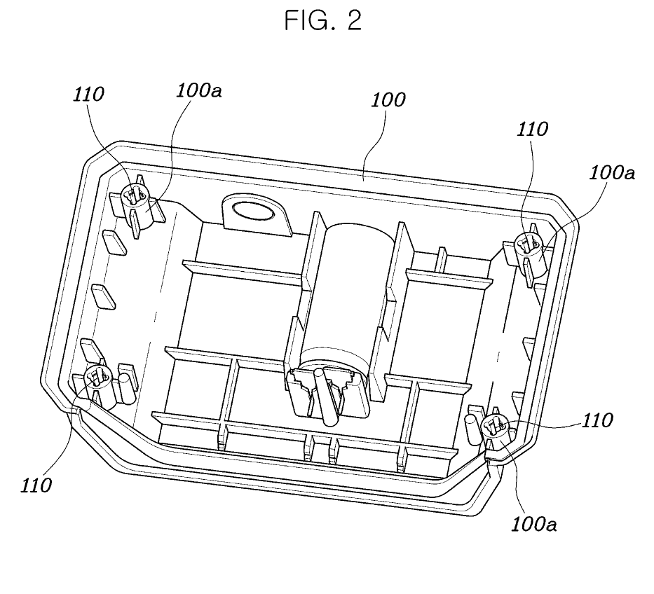

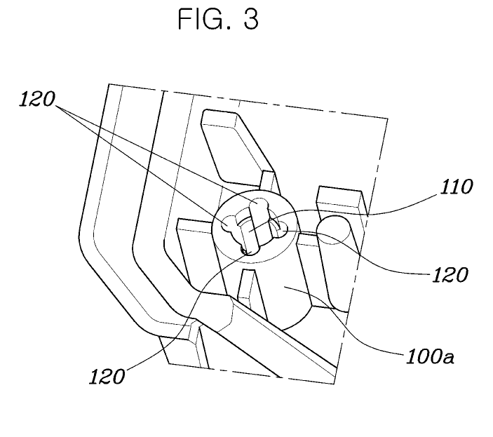

Referring to FIGS. 1-3, a controller (e.g., integrated safety control module) that controls deployment of an airbag may largely include a first part 100, a second part 200, and an assembly part 300, and these components may be assembled by a fastener 400.

For example, the first part 100 may be a housing, the second part 200 may be “a base plate”, the assembly part 300 may be “a board assembly”, and the fastener 400 may be “a screw”.

Accordingly, hereinafter, the first part 100, the second part 200, the assembly part 300, and the fastener 400 will be described as a housing 100, a base plate 200, a board assembly 300, and a screw 400, respectively.

The housing 100 is formed in a rectangular box shape, a boss portion 100a is formed at each of four corners of the housing 100, and an assembly hole 110 may be formed in a vertical direction at a center of the boss portion 100a.

In particular, a sealing groove 120 is formed at an inner surface of the assembly hole 110, and sealant S may be injected into the assembly hole 110.

By the sealing groove 120 being formed to communicate with the assembly hole 110, when the sealant S is injected into the assembly hole 110, the sealant S is filled in an interior of the assembly hole 110 and an interior of the sealing groove 120.

A rectangular base plate 200 is covered on an upper surface of the housing 100.

A through hole 210 may be formed at each of four corners of the base plate 200.

Accordingly, a screw 400 may extend through the base plate 200 and be fastened to the assembly hole 110.

In particular, in a process in which the screw 400 is fastened to the assembly hole 110, the screw 400 applies pressure pressing the sealant S in the assembly hole 110, so that the sealant S rises upward along the assembly hole 110 and the sealing groove 120.

Therefore, since the sealant S rises entirely between an outer surface of the screw 400 and inner surfaces of the assembly hole 110 and the sealing groove 120, airtight performance and waterproof performance are improved by preventing water or air from entering between the housing 100 and the base plate 200.

According to an embodiment of the present disclosure, the sealant S may rise up to a head portion of the fastener 400.

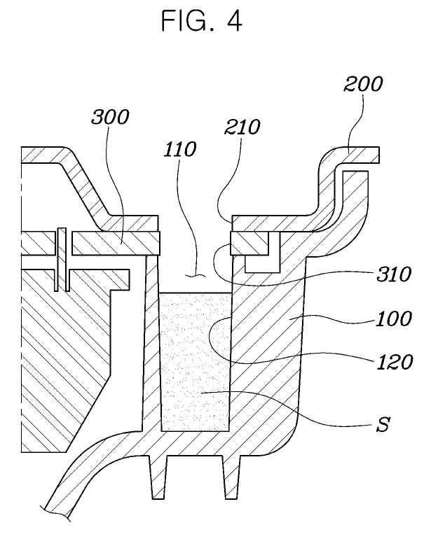

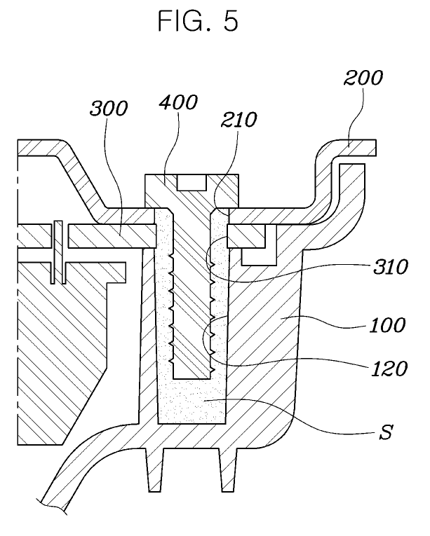

As shown in FIGS. 4 and 5, in a process in which the screw 400 is fastened to the assembly hole 110, the sealant S injected into the assembly hole 110 rises through the assembly hole 110 and the sealing groove 120, and in particular, the sealant S rises up to below the head portion of the screw 400 and is closely contacted to a lower surface of the head portion.

Therefore, airtight performance and waterproof performance are improved by blocking water or air from entering between the screw 400 and the base plate 200.

Furthermore, an injection amount of the sealant S is appropriately adjusted so that the sealant S may rise only up to the head portion, and accordingly, the sealant S is not excessively injected, so that an application amount of the sealant S may be reduced.

According to the disclosed embodiment, at least one assembly part 300 may be assembled between the first part 100 and the second part 200.

In particular, a through hole 210, 310 aligned with the assembly hole 110 is formed in the second part 200 and the assembly part 300; and the sealant S may be filled in the through hole 210, 310.

Referring to FIGS. 4 and 5, a board assembly 300 including a board may be assembled between the housing 100 and the base plate 200.

A through hole 310 aligned with the assembly hole 110 is formed at each of four corners of the board assembly 300, and a through hole 210 aligned with the assembly hole 110 may also be formed at each of four corners of the base plate 200.

Accordingly, the sealant S rising through the assembly hole 110 is filled in the through hole 310 of the board assembly 300 and the through hole 210 of the base plate 200.

Therefore, airtight performance and waterproof performance are improved by blocking water or air from entering between the housing 100 and the board assembly 300 and between the board assembly 300 and the base plate 200.

Meanwhile, in the present disclosure, the sealing groove 120 may be formed in a circular cross-sectional shape smaller than the assembly hole 110 at least one location along a circumferential direction of the assembly hole 110.

Furthermore, a plurality of sealing grooves 120 may be formed at equal angles along a circumferential direction about an axis of the assembly hole 110.

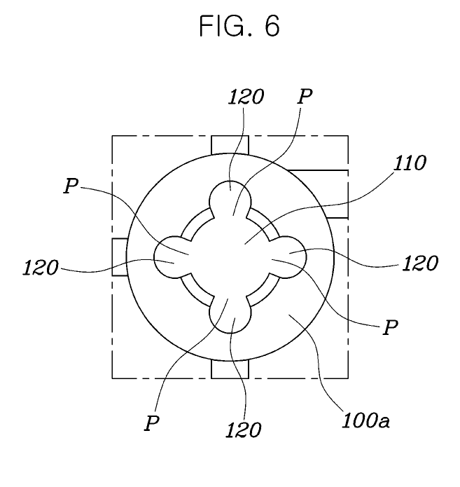

Referring to FIG. 6, by at least one sealing groove 120 space where the sealant S may rise being formed at an inner surface of the assembly hole 110, the sealant S may easily rise.

In particular, by four sealing grooves 120 being disposed at equal angles of 90° along a circumference of the assembly hole 110, the sealant S rises entirely and uniformly along the circumference of the assembly hole 110, thereby securing stable sealing performance and structure.

In addition, a cross-sectional area where the fastener 400 contacts, among a total cross-sectional area formed by an inner circumferential surface of the assembly hole 110, may be formed wider than a cross-sectional area of a passage P formed between the assembly hole 110 and the sealing groove 120.

Referring to FIG. 6, a cross-sectional area of four portions where the screw 400 contacts among an entire inner circumferential surface of the assembly hole 110 may be formed larger than a cross-sectional area of four passages P communicating with the sealing groove 120.

(Σ contact area of screw 400 > Σ area of passage P)

As such, since an area where the screw 400 contacts is larger than an area of the passage P, assembly rigidity of the screw 400 is prevented from being weakened.

Meanwhile, the sealing groove 120 may be formed along a vertical length direction of the assembly hole 110.

Accordingly, the sealant S may rise upward along the sealing groove 120 together with the assembly hole 110.

In particular, an inner surface of the sealing groove 120 may be formed inclined upward toward an outer side of the boss portion 100a.

Preferably, the inner surface of the sealing groove 120 may be formed inclined from a lowermost end to an uppermost end.

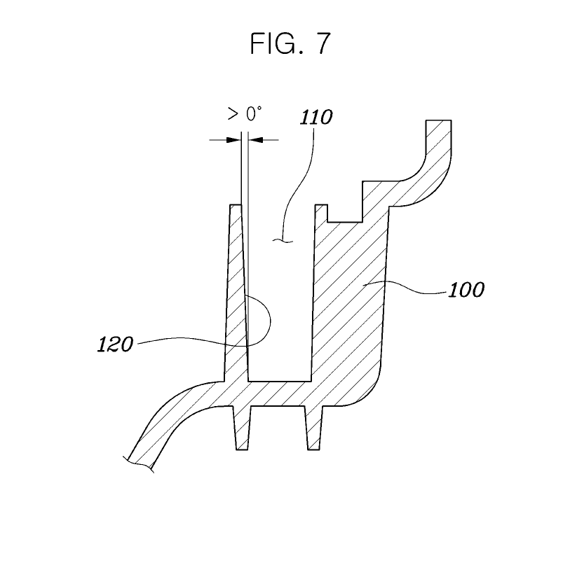

Referring to FIG. 7, the sealing groove 120 is formed inclined upward in an outward direction from the lowermost end, and the inclined shape continues to the uppermost end.

Therefore, the sealant S may smoothly rise along the inclined surface formed at an inner surface of the sealing groove 120, thereby securing sealing performance.

As such, according to the present disclosure, upon fastening of the screw 400, since the sealant S rises entirely between an outer surface of the screw 400 and inner surfaces of the assembly hole 110 and the sealing groove 120, airtight performance and waterproof performance are improved by preventing water or air from entering between the housing 100 and the base plate 200.

Although the present disclosure has been illustrated and described in connection with specific embodiments thereof, it is apparent to those of ordinary skill in the art that the invention may be variously improved and changed without departing from the technical spirit of the disclosed embodiments provided by the following claims.

What is claimed is:

1. A fastener assembly structure comprising:
a first part having (1) an assembly hole at a center of a boss portion and (2) a sealing groove having a structure communicating with an inner surface of the assembly hole such that sealant is injected into an interior thereof;
a second part shaped to cover the first part; and
a fastener extending through the second part and assembled to the assembly hole,
wherein as the fastener is assembled to the assembly hole, the sealant rises along the assembly hole and the sealing groove by pressure pressing the sealant to be sealed.

2. The fastener assembly structure of claim 1, wherein the sealant rises up to a head portion of the fastener.

3. The fastener assembly structure of claim 2, wherein at least one assembly part is assembled between the first part and the second part.

4. The fastener assembly structure of claim 3, wherein:
the second part and the at least one assembly part have a through hole aligned with the assembly hole; and
the sealant is filled in the through hole.

5. The fastener assembly structure of claim 1, wherein the sealing groove has a circular cross-sectional shape smaller than the assembly hole at least one location along a circumferential direction of the assembly hole.

6. The fastener assembly structure of claim 1, wherein the sealing groove comprises a plurality of sealing grooves disposed at equal angles along a circumferential direction about an axis of the assembly hole.

7. The fastener assembly structure of claim 1, wherein a cross-sectional area where the fastener contacts, among a total cross-sectional area formed by an inner circumferential surface of the assembly hole, is wider than that of a passage formed between the assembly hole and the sealing groove.

8. The fastener assembly structure of claim 1, wherein the sealing groove extends along a vertical length direction of the assembly hole.

9. The fastener assembly structure of claim 8, wherein an inner surface of the sealing groove is inclined upward toward an outer side of the boss portion.

10. The fastener assembly structure of claim 9, wherein the inner surface of the sealing groove is inclined from a lowermost end to an uppermost end.
